(19) United States
(12) Patent Application Publication
(10) Pub. No.: US 2004/0139825 A1
(43) Pub. Date: Jul. 22, 2004

(54) Engagement structure of C-shaped clamp and engaging ring of head ratchet tools

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/347,205

(22) Filed: Jan. 21, 2003

(51) Int. Cl. B25B 13/46

(52) U.S. Cl. 81/63.2

(57) ABSTRACT

A ratchet tool includes a head and an engaging ring is rotatably received therein. The head has a first opening and a second opening respectively defined in two sides of the head. A first stepped portion and a second stepped portion are respectively defined in an inside of a periphery of the first opening and the second opening. The engaging ring has two necks respectively extend from two opposite ends of the engaging ring and one of the necks has a flange extending outward from a distal edge thereof so as to define a groove between an end of the teeth and the flange. The second stepped portion has an inclined inside so that a C-shaped clamp is easily engaged with the groove and the second stepped portion via the inclined inside.

### FIELD OF THE INVENTION

The present invention relates to ratchet tool and the C-shaped clamp is easily and convenient engaged with the groove in the engaging ring and a stepped portion in an inside of the hole in the head of the ratchet tool.

### BACKGROUND OF THE INVENTION

Referring to FIG. 6, a first conventional ratchet tool generally includes an engaging ring 70 that is rotatably received in a hole defined through the head 80 of the ratchet tool and teeth 71 are defined in an outer periphery of the engaging ring 70. A pawl (not shown) is received in the head 10 and engaged with the teeth 71 of the engaging ring 70. The engaging ring 70 has a groove 72 defined in the outer periphery thereof and another groove 81 is defined in an inner periphery of hole of the head 80 so as to prevent the engaging ring 70 from dropping the hole of the head 80. In order to conveniently insert the clamp 90 into the two grooves 72 and 81, the tolerance of the two grooves 72, 81 is large enough such that the assemblers may easily put the clamp into the grooves 72, 81. Nevertheless, this tolerance makes the engaging ring 70 shake during use.

Referring to FIG. 7, if the tolerance is reduced, it is difficult to insert the clamp 90 because the outer periphery of the clamp 90 interferes the insertion of the head 80 so that the clamp 90 is stopped by the clamp 90. Besides, even if the clamp 90 is successfully engaged with the grooves 72 and 81, as shown in FIG. 8, the engaging ring 70 is firmly biased by the clamp 90 and cannot rotate smoothly.

The present invention intends to provide a ratchet tool wherein either the groove in the inner periphery of the hole of the head or the groove in the engaging ring has an inclined surface so as to easily install the clamp in the grooves.

### SUMMARY OF THE INVENTION

In accordance with one aspect of the present invention, there is provided a ratchet tool which comprises a head which has a hole for receiving an engaging ring therein and the hole includes a first opening and a second opening respectively defined in a first side and a second side of the head. A first stepped portion is defined in an inside of a periphery of the first opening and a second stepped portion is defined in an inside of a periphery of the second opening. The engaging ring has two necks respectively extending from two opposite ends of the engaging ring. An outer diameter of the necks is smaller than an outer diameter of the teeth on the engaging ring so that the teeth are engaged with a pawl received in the head. One of the necks has a flange extending outward from a distal edge thereof so as to define a groove between an end of the teeth and the flange. The other neck is engaged with the first stepped portion. The second stepped portion has an inclined inside so that a C-shaped clamp is engaged with the groove and slid in the second stepped portion via the inclined inside.

The primary object of the present invention is to provide head that has an inclined inside defined in a stepped portion of the opening of the hole so that the C-shaped clamp is easily slid into the stepped portion and the groove defined in the engaging ring while the engaging ring is properly positioned and does not shake during use.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the ratchet tool of the present invention;

FIG. 2 shows the head, partly removed, of the ratchet tool of the present invention;

FIG. 3 shows a cross sectional view of the ratchet tool of the present invention, wherein the second stepped portion has an inclined inside;

FIG. 4 is a perspective view to show the engaging ring of the present invention;

FIG. 5 is a cross sectional view to show that a C-shaped clamp is engaged in the groove of the engaging ring and the head of the ratchet tool of the present invention, wherein the end of the teeth of the engaging ring has an inclined edge;

FIG. 6 is a cross sectional view to show that a C-shaped clamp is engaged in the groove of the engaging ring and the head of the conventional ratchet tool,

FIG. 7 shows if the C-shaped clamp is tightly fitted in the groove of the engaging ring, it is difficult to be engaged with the head, and

FIG. 8 shows the C-shaped clamp could limit rotation of the engaging ring in a conventional ratchet tool.

### DETAILED DESCRIPTION OF THE PREFERRED EMBODIMENT

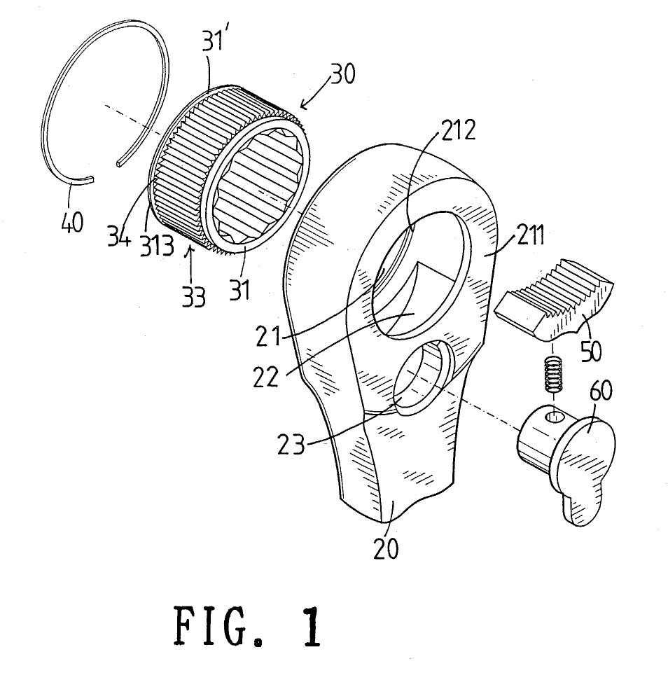

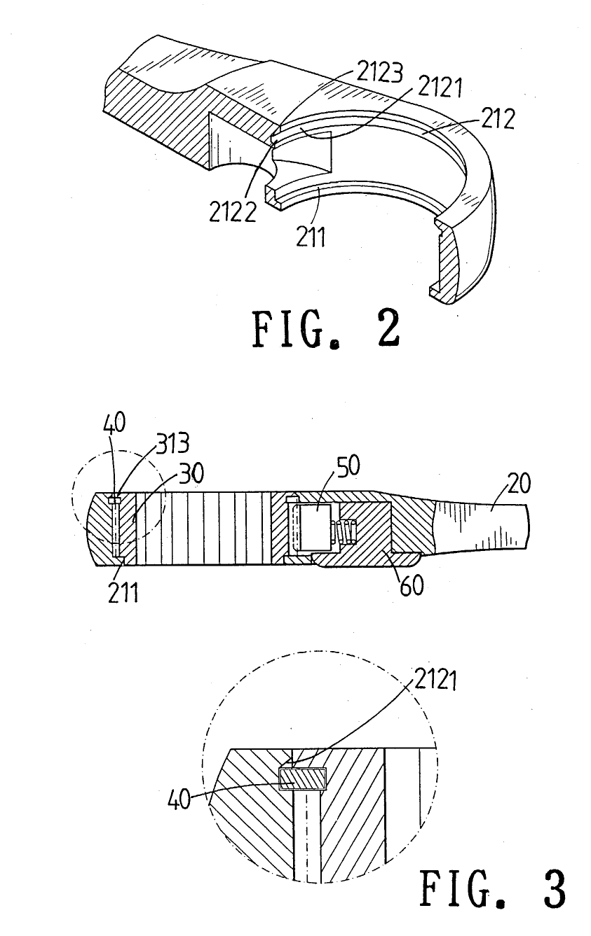

Referring to FIGS. 1 to 3, the ratchet tool of the present invention comprises a head 20 having a hole 21 defined therethrough and a chamber 22 is defined in an inner periphery of the hole 21. A pawl 50 is received in the chamber 22 and controlled by a control member 60 which is rotatably received in a hole 23 defined in a first side of the head 20. A first opening is defined in the first side of the head 20 and communicates with the hole 21. A first stepped portion 211 is defined in an inside of a periphery of the first opening. A second opening is defined in a second side of the head 20 and communicates with the hole 21. A second stepped portion 212 is defined in an inside of a periphery of the second opening and includes an inclined inside 2121, a horizontal inside 2122 and an end periphery 2123 which is connected between the inclined inside 2121 and the horizontal inside 2122.

An engaging ring 30 has teeth 33 defined longitudinally in an outer periphery thereof and a polygonal inner periphery is defined in the engaging ring 30. Two necks 31, 31′ respectively extend from two opposite ends of the engaging ring 30. An outer diameter of the necks 31, 31′ is smaller than an outer diameter of the teeth 33 on the engaging ring 30 so that the teeth 33 can be engaged with the engaging teeth defined in a side of the pawl 50. The necks 31′ has a flange 313 extending outward from a distal edge thereof so as to define a groove 34 between an end 313 of the teeth 33 and the′ flange 35.

The engaging ring 30 is rotatably received in the hole 21 and the neck 31 is engaged with the first stepped portion 211. A C-shaped clamp 40 is engaged with the groove 34 in the engaging ring 30 and the second stepped portion 212. It is to be noted that the C-shaped clamp 40 is easily inserted in the second stopped portion 212 via the inclined inside 2121 when assembling. By the inclined inside 2121, the C-shaped clamp 40 can be made to be snugly engaged with the groove 34 so that the engaging ring 30 does not shake. This makes the installation of the engaging ring 30 be convenient and easily by simply inserting the C-shaped clamp 40 into the groove 34 and the second stepped portion 212.

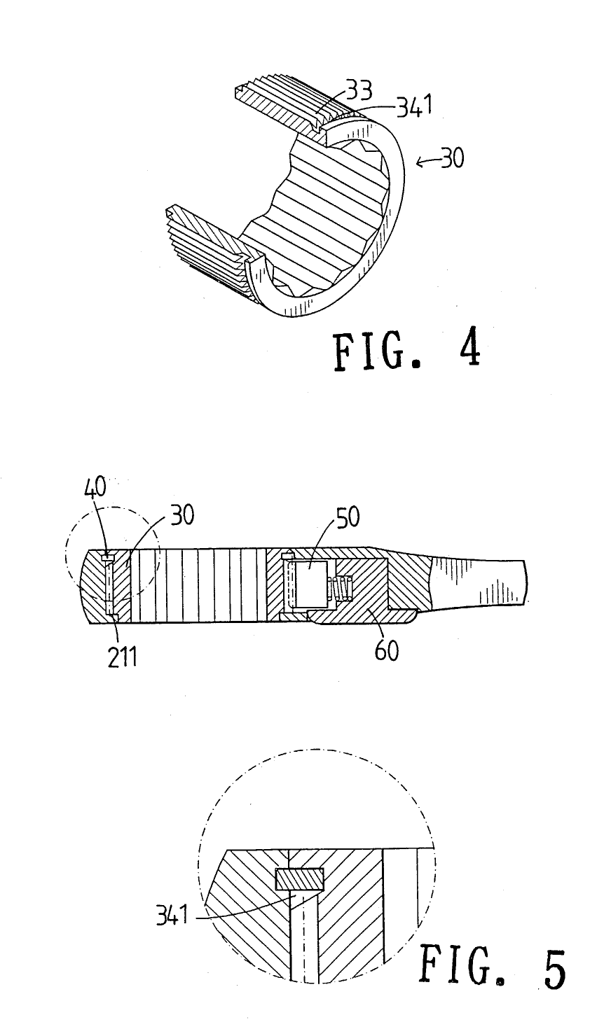

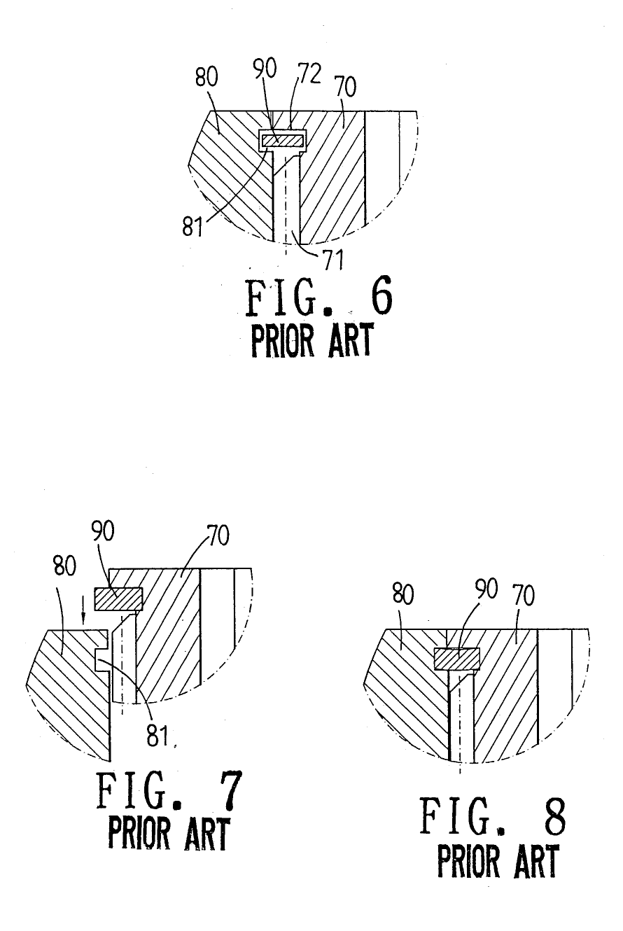

Referring to FIGS. 4 and 5, the end of the teeth 33 may have an inclined edge 341 so that a gap is defined between the inclined edge 341 of the teeth 33 and the C-shaped clamp 40. By this arrangement, the friction between the teeth 33 and the C-shaped clamp 40 can be reduced and the assembling processes can also be simplified.

While we have shown and described the embodiment in accordance with the present invention, it should be clear to those skilled in the art that further embodiments may be made without departing from the scope of the present invention.

What is claimed is:

1. A ratchet tool comprising:
a head having a hole defined therethrough and a chamber defined in an inner periphery of the hole, a first opening defined in a first side of the head and communicating with the hole, a first stepped portion defined in an inside of a periphery of the first opening, a second opening defined in a second side of the head and communicating with the hole, a second stepped portion defined in an inside of a periphery of the second opening;
an engaging ring rotatably received in the hole and having teeth defined longitudinally in an outer periphery thereof, two necks respectively extending from two opposite ends of the engaging ring, an outer diameter of the necks being smaller than an outer diameter of the teeth on the engaging ring, one of the necks having a flange extending outward from a distal edge thereof so as to define a groove between an end of the teeth and the flange, a C-shaped clamp engaged with the groove and the second stepped portion, the second stepped portion having an inclined inside so that the C-shaped clamp being slid in the second stepped portion via the inclined inside, the other neck engaged with the first stepped portion, and a pawl received in the chamber and having engaging teeth defined in a side thereof, the engaging teeth engaged with the teeth of the engaging ring, a control member operatively connected to the other side of the pawl.

2. The ratchet tool as claimed in claim 1, wherein the end of the teeth has an inclined edge so that a gap is defined between the end of the teeth and the C-shaped clamp
